(19) United States
(12) Patent Application Publication
(10) Pub. No.: US 2010/0102195 A1
(43) Pub. Date: Apr. 29, 2010

(54) Recycled tire pad with protrusions

(75) Inventors: Robert F. Williams, Edison, NJ (US); Robert J. Williams, Edison, NJ (US)

Correspondence Address: Deirdra M. Meagher;GlynnTech, Inc., 24 Mine Street, Flemington, NJ, 08822, US

(73) Assignees: iVoice Technology, Inc.; B Green Innovations, Inc.

(21) Appl. No.: 12/290,224

(22) Filed: Oct. 28, 2008

(51) Int. Cl. F16M 13/00

(52) U.S. Cl. 248/633

(57) ABSTRACT

The present invention relates to a recycled tire anti-vibration pad with protrusions which includes at least one anti-vibration pad composed entirely of fused shredded rubber from used tires. The anti-vibration pad includes at least one sidewall, a top and a bottom. The top has a plurality of protrusions and is adapted for placement under a potentially vibrating appliance. The bottom has a plurality of recesses extending at least half way into the at least one anti-vibration pad and is adapted for placement on a surface where the potentially vibrating appliance is placed. The at least one anti-vibration pad reduces noise and vibration of the potentially vibrating appliance when the at least one anti-vibration pad is placed under the potentially vibrating appliance. The plurality of protrusions may be textured.

### BACKGROUND OF INVENTION

a. Field of Invention

The invention relates generally to recycled tire anti-vibration pads for reducing noise and vibration. More specifically, the pads include a plurality of protrusions and a plurality of recesses. The pads are composed entirely of fused shredded rubber from used tires.

b. Description of Related Art

The following patents are representative of anti-vibration pads:

U.S. Pat. No. 7,300,032 B2 to Williams et al. describes a base pad which is for supporting mechanical machines and equipment and which is configured such that it reduces the noise and vibration emanating from these machines. The pad is constructed entirely from shredded and comminuted rubber tires and is configured such that it provides for the efficient run-off and/or draining of any moisture generated from under the machine unit.

U.S. Pat. No. 6,692,047 B1 to Solon describes a flexible impact energy absorption resilient and flexible rubber strip accessory has an adhesive layer for affixing it to an exterior curved automobile body surface. An inexpensive preferred embodiment is formed using tire tread strips cut from the carcasses of discarded automobile tires. Thus, steel belted tires provide embedded reinforcement for absorbing higher levels of impact energy without any visible damage to the tread strip or the adjacent car body surface upon which it is affixed. This accessory has an adhesive layer for attachment to a car surface having a manually protective paper or plastic cover so that it may be retrofit upon an exterior surface of an automobile without requiring any special tools. The accessory is universally adaptable to a large range of automobile body styles.

U.S. Pat. No. 6,444,067 B1 to Bove et al. describes a process for manufacturing structures from worn out tires and a parking stop made by that process. Sidewalls are cut from the tire leaving a circular strip, which is cut transversely to produce an elongated approximately rectangular strip. Spaced slits are cut into the long edges of the strips to form slats suitable for use in manufacturing structures. Two slats are bonded together in a face-to-face arrangement to form a unitary pair of bonded slats. Additional pairs of slats are then bonded to the first pair of slats. All slats are bonded with similar sides in contact; that is, tread side to tread side or inside to inside. The resulting beam can have adjacent corners removed to provide a parking stop configuration. Preferably, the slats are bonded with an elastomer or mechanical fasteners such as ring nails or staples. A thick elastomer, having a thickness of at least about ⅛ inch may be coated over the beam. Beams may be combined to form guard rails, walls, panels, etc.

U.S. Pat. No. 6,050,539 to Millen describes a support pad which is provided having a lightweight core component defining an essentially open space between side walls thereof. An interlocking pattern, such as alternating recesses and extensions, are defined along the side walls of the core component. A hard formable shell material, such as concrete, generally surrounds the core component along the side walls and upper surface thereof. The shell material forms within the recesses along at least one of the side walls and non-movably sets the core component within the shell material. The interlocking pattern or recesses defined on the sides of the core component are configured so that any number of pattern of core components can be interconnected depending on the sides and configuration of the desired support pad.

U.S. Pat. No. 5,834,083 to Pignataro, Jr. describes used tires that are sorted on-site to separate those which are still good from those that are scrap. At the site, the sidewalls are separated from each scrap tire and the remaining tire portion is slit transversely and laid flat, stacked one atop the other. The stack is transported by vehicle from the site to a central processing facility that shears the tire portions to a uniform width and thickness. The uniformly dimensioned tire portions are then connected into strips by male/female dovetail cuts. Two strips are bonded together at their flat inner tire sides to form a two-ply tread strip. The two-ply tread strips are then used in construction, building component manufacture, fencing or landscaping; the two-ply treads are more flexible then lumber. The sidewalls are used as landfill or grounds cover in landscaping.

U.S. Pat. No. 5,573,220 to Whittaker et al. describes a heavy duty vibration absorbing and leveling machinery foundation mount and a method for turning the same, the mount consisting of a rigid horizontal platform having a plurality of vibration absorbing legs. A leveler is mounted in the central region of the platform having a vertically adjustable riser, and the legs are formed by pockets housing a composite vibration absorbing material extending below the platform and engaging the surface upon which the machinery mount is supported which may be tuned to most effectively absorb the vibration to which the mount is subjected.

U.S. Pat. No. 4,493,471 to McInnis describes a speaker stand for supporting a speaker enclosure on the floor comprising a rigid planar member (11) supporting a waffled cushion pad (12) on the top surface with the pad including peaks 17 and valleys 19. Semire-silient rails (13,14,15,16) positioned to the side of said pad support and stabilize the speaker enclosure such that the pad is depressed sufficiently to form air pockets between the pad and speaker enclosure in the areas of the valleys to attenuate vibratory motion and acoustic sound wave transmissions between the speaker and floor.

U.S. Pat. No. 4,273,213 to Munz describes the present invention which is concerned with an element for the sonic and vibratory absorption, comprising a ledge having ribs of flexible material longitudinally extending along the top and bottom sides, with the top-side ribs over the bottom-side ribs being arranged in staggered relationship. According to the invention, such an element is improved in that provided between respectively two ribs of approximately trapezoidal cross-section is another rib equally of approximately trapezoidal cross-section of an inferior height, which continues to extend through the central area of the element upwardly and downwardly, respectively, in the respective rib of greater height, and that at least on one longitudinal side of the element a stop is provided extending over the entire length of the element.

U.S. Pat. No. 4,002,315 to Van Goubergen describes the invention which concerns a vibration damping mat having on either side projections that, when stacking a number of such mats, so engage each other that the assembly behaves like a single thicker mat having the lateral stability of a single mat and having the same differentiated damping effect for different vibration amplitudes as a single mat, however with a different absorption percentage.

Notwithstanding the prior art, the present invention is neither taught nor rendered obvious thereby.

### SUMMARY OF THE INVENTION

The present invention relates to a recycled tire anti-vibration pad with protrusions which includes at least one anti-vibration pad composed entirely of fused shredded rubber from used tires. The anti-vibration pad includes at least one sidewall, a top and a bottom. The top has a plurality of protrusions and is adapted for placement under a potentially vibrating appliance. The bottom has a plurality of recesses extending at least half way into the at least one anti-vibration pad and is adapted for placement on a surface where the potentially vibrating appliance is placed. The at least one anti-vibration pad reduces noise and vibration of the potentially vibrating appliance when the at least one anti-vibration pad is placed under the potentially vibrating appliance.

In some embodiments, the plurality of protrusions is in a fixed pattern. In other embodiments, the plurality of protrusions is in a symmetrical predetermined pattern. The shape of the protrusions is selected from the group consisting of circular, oval, square, rectangular, triangular, hexagonal, octagonal, polygonal, and combinations thereof.

In some embodiments, the plurality of recesses is in a fixed pattern while in other embodiments, the plurality of recesses is in a symmetrical predetermined pattern. The shape of the plurality of recesses is selected from the group consisting of circular, oval, square, rectangular, triangular, hexagonal, octagonal, polygonal, and combinations thereof. In some embodiments, each of the recesses includes a top and a bottom and wherein an area of the recess from a two-dimensional perspective parallel to the bottom of the at least one anti-vibration pad increases from a bottom of the recess to a top of the recess.

In some preferred embodiments, an extended footprint view from the top is selected from the group consisting of circular, oval, square, rectangular, triangular, hexagonal, octagonal and polygonal.

In other embodiments, the least one anti-vibration pad is textured in a portion separate from the plurality of recesses.

In another preferred embodiment of the present invention, a recycled tire anti-vibration pad with protrusions has at least one anti-vibration pad composed entirely of fused shredded rubber from used tires. Each anti-vibration pad has at least one sidewall, a top and a bottom. The top has a plurality of textured protrusions and is adapted for placement under a potentially vibrating appliance. The bottom has a plurality of recesses extending at least half way into the at least one anti-vibration pad and is adapted for placement on a surface where the potentially vibrating appliance is placed. The at least one anti-vibration pad reduces noise and vibration of the potentially vibrating appliance when the at least one anti-vibration pad is placed under the potentially vibrating appliance.

In some embodiments, the plurality of textured protrusions is in a fixed pattern. In other embodiments, the plurality of textured protrusions is in a symmetrical predetermined pattern. The shape of the textured protrusions is selected from the group consisting of circular, oval, square, rectangular, triangular, hexagonal, octagonal, polygonal, and combinations thereof.

In some embodiments, the plurality of recesses is in a fixed pattern while in other embodiments, the plurality of recesses is in a symmetrical predetermined pattern. The shape of the is selected from the group consisting of circular, oval, square, rectangular, triangular, hexagonal, octagonal, polygonal, and combinations thereof.

In some preferred embodiments, in which of the recesses has a top and a bottom, the area of the recess from a two-dimensional perspective parallel to the bottom of the at least one anti-vibration pad increases from a bottom of the recess to a top of the recess.

An extended footprint view from the top is selected from the group consisting of circular, oval, square, rectangular, triangular, hexagonal and polygonal.

In some preferred embodiments, the at least one anti-vibration pad is textured in its entirety.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIGS. 1, 2 and 3 are a top view, a bottom view and a side view, respectively, of one embodiment of a present invention recycled tire anti-vibration pad with protrusions, illustrating fixed patterns for a plurality of protrusions and a plurality of recesses;

FIGS. 4, 5 and 6 are a top view, a bottom view and a side view, respectively, of another embodiment of a present invention recycled tire anti-vibration pad with protrusions, illustrating symmetrical predetermined patterns for a plurality of protrusions and a plurality of recesses;

FIGS. 7, 8 and 9 are a top view, a bottom view and a side view, respectively, of yet another embodiment of a present invention recycled tire anti-vibration pad with protrusions, illustrating different shapes for a plurality of protrusions; and,

FIGS. 10, 11 and 12 are a top view, a bottom view and a side view, respectively, of yet another embodiment of a present invention recycled tire anti-vibration pad with protrusions, illustrating a different shape for the extended footprint view from a top perspective.

### DETAILED DESCRIPTION OF THE EMBODIMENTS

The present invention relates to a recycled tire anti-vibration pad with protrusions which includes at least one anti-vibration pad composed entirely of fused shredded rubber from used tires. The anti-vibration pad includes at least one sidewall, a top and a bottom. The top has a plurality of protrusions and is adapted for placement under a potentially vibrating appliance. The bottom has a plurality of recesses extending at least half way into the at least one anti-vibration pad and is adapted for placement on a surface where the potentially vibrating appliance is placed. The at least one anti-vibration pad reduces noise and vibration of the potentially vibrating appliance when the at least one anti-vibration pad is placed under the potentially vibrating appliance. The plurality of protrusions may be textured.

The potentially vibrating appliance may include furnaces, air handlers, air conditioning units, washers, dryers, pumps, motors, air compressors, computers and the like. In addition to reducing noise and vibration, a reduction in energy consumption, component wear and costly repairs is also accomplished by the use of the anti-vibration pads.

The plurality of protrusions is in a fixed pattern or in a symmetrical predetermined pattern. The shape of the protrusions may be circular, oval, square, rectangular, triangular, hexagonal, octagonal, polygonal, and combinations thereof. The plurality of protrusions facilitates the reduction of noise and vibration.

The plurality of recesses is in a fixed pattern or in a symmetrical predetermined pattern. The shape of the plurality of recesses may be circular, oval, square, rectangular, triangular, hexagonal, octagonal, polygonal, and combinations thereof. The plurality of recesses facilitates the reduction of noise and vibration.

Each of the recesses includes a top and a bottom. An area of the recess from a two-dimensional perspective parallel to the bottom of the at least one anti-vibration pad may be tapered and thus increases from a bottom of the recess to a top of the recess. In other embodiments, the area of the recess from a two-dimensional perspective remains constant.

An extended footprint view from the top is selected may be circular, oval, square, rectangular, triangular, hexagonal, octagonal and polygonal. Furthermore, the anti-vibration pad may be entirely textured.

The fused shredded rubber from used tires, which composes the present invention anti-vibration pad, may be obtained as shredded rubber from waste dumps and recycling facilities providing scrap tires. A mold is previously made allowing for the desired shape and attachment means requirements, typically a plurality of orifices. The scrap tires are cut or shredded to a predetermined size that is manageable for processing and are heat-processed and placed into the mold through injection and/or pressing. Manageable sizes are typically below about 0.15 inches and preferably about 0.10 inches and less in maximum cross section. The shredded rubber may be heated prior to or after being placed in the mold, or both. Upon cooling, the mold is removed to provide the anti-vibration. Heating may be for a few minutes or longer and heat temperatures may be within any temperature or range wherein the shredded tire rubber begins to melt, but should not be fully melted. The objective is to fuse the cut or shredded pieces so that they fuse together and form a single structure, in many cases with a resulting grainy heterogeneous topography wherein the fused pieces can be seen.

The use of the shredded rubber from used tires provides greening by saving the environment from the breakdown of the rubber and potential fire hazards by chemical reactions of the rubber with soil and air. Thus, a waste disposal problem and an environmental problem are eliminated by use of scrap tires.

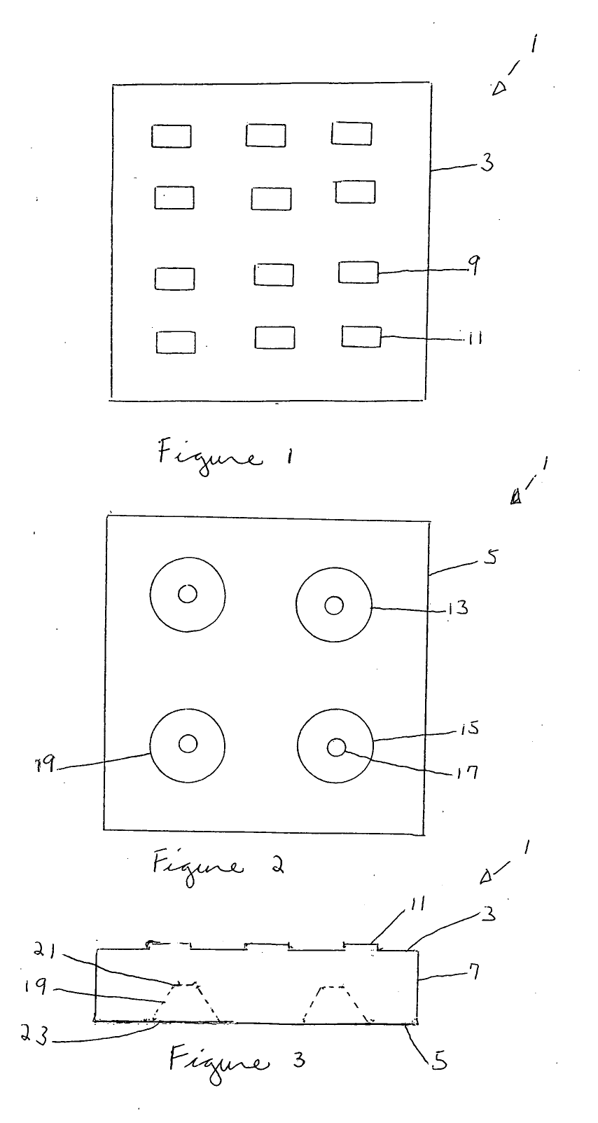

Referring now to the drawings wherein like reference numerals designate corresponding parts throughout the several views, FIGS. 1, 2 and 3 are a top view, a bottom view and a side view, respectively, of one embodiment of a present invention recycled tire anti-vibration pad with protrusions 1, illustrating fixed patterns for a plurality of protrusions 9, 11 and a plurality of recesses 13, 15, 19.

The anti-vibration pad 1 includes at least one sidewall 7, a top 3 and a bottom 5. The top 3 has a plurality of protrusions 9, 11 and is adapted for placement under a potentially vibrating appliance. The bottom 5 has a plurality of recesses 13, 15 extending at least half way into the at least one anti-vibration pad 1 and is adapted for placement on a surface where the potentially vibrating appliance is placed. The at least one anti-vibration pad 1 reduces noise and vibration of the potentially vibrating appliance when the at least one anti-vibration pad 1 is placed under the potentially vibrating appliance.

In this embodiment, the plurality of protrusions 9, 11 is in a fixed pattern of three rectangles across the width and four rectangles down the length. Although the protrusions 9, 11 are shown as rectangles, the shape of the protrusions may be circular, oval, square, rectangular, triangular, hexagonal, octagonal, polygonal, and combinations thereof. The protrusions 9, 11 may be textured.

In this embodiment, the plurality of recesses 13, 15, 19 is in a fixed pattern of two circles each across the width and length. Although the recesses are shown as circles, the shape of the recesses 13, 15, 19 may be circular, oval, square, rectangular, triangular, hexagonal, octagonal, polygonal, and combinations thereof. Each of the recesses 13, 15, 19 includes a top 23 and a bottom 21. The recesses are tapered as illustrated by a smaller dimensioned circle 17 within the recess 15. Thus, an area of each recess 13, 15, 19 from a two-dimensional perspective parallel to the bottom 5 of the at least one anti-vibration pad 1 increases from the bottom 21 of the recess 19 to the top 23 of the recess 19.

In this embodiment, an extended footprint from a top view 3 is square. However, the extended footprint view from the top may be circular, oval, square, rectangular, triangular, hexagonal, octagonal and polygonal.

The least one anti-vibration pad 1 may be textured in a portion separate from the plurality of protrusions.

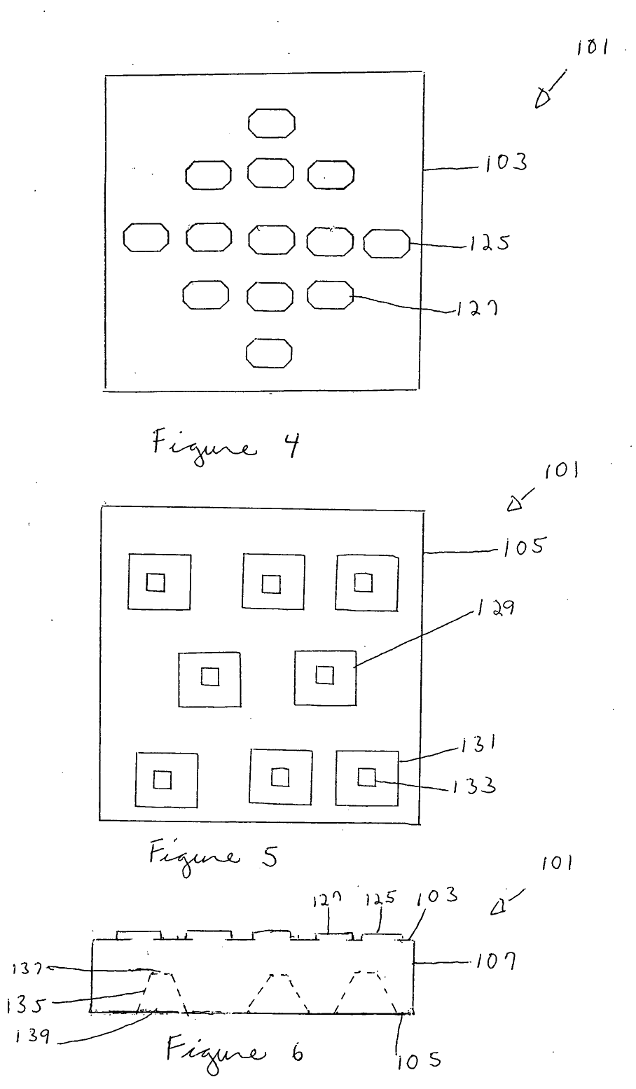

FIGS. 4, 5 and 6 are a top view, a bottom view and a side view, respectively, of another embodiment of a present invention recycled tire anti-vibration pad with protrusions 101, illustrating symmetrical predetermined patterns for a plurality of protrusions 125, 127 and a plurality of recesses 129, 133, 135.

The anti-vibration pad 101 includes at least one sidewall 107, a top 103 and a bottom 105. The top 103 has a plurality of protrusions 125, 127 and is adapted for placement under a potentially vibrating appliance. The bottom 105 has a plurality of recesses 129, 133, 135 extending at least half way into the at least one anti-vibration pad 101 and is adapted for placement on a surface where the potentially vibrating appliance is placed. The at least one anti-vibration pad 101 reduces noise and vibration of the potentially vibrating appliance when the at least one anti-vibration pad 101 is placed under the potentially vibrating appliance.

In this embodiment, the plurality of protrusions 125, 127 is in a symmetrical predetermined pattern of an increasing number of octagons. Although the protrusions 125, 127 are shown as octagons, the shape of the protrusions may be circular, oval, square, rectangular, triangular, hexagonal, octagonal, polygonal, and combinations thereof. The protrusions 125, 127 may be textured.

In this embodiment, the plurality of recesses 129, 131, 135 is in a symmetrical predetermined pattern of staggered placement of squares within the length. Although the recesses are shown as squares, the shape of the recesses 129, 131, 135 may be circular, oval, square, rectangular, triangular, hexagonal, octagonal, polygonal, and combinations thereof. Each of the recesses 129, 131, 135 includes a top 139 and a bottom 137. The recesses are tapered as illustrated by a smaller dimensioned circle 133 within the recess 131. Thus, an area of each recess 129, 131, 135 from a two-dimensional perspective parallel to the bottom 105 of the at least one anti-vibration pad 101 increases from the bottom 137 of the recess 135 to the top 139 of the recess 135.

In this embodiment, an extended footprint from a top 103 view is square. However, the extended footprint view from the top may be circular, oval, square, rectangular, triangular, hexagonal, octagonal and polygonal.

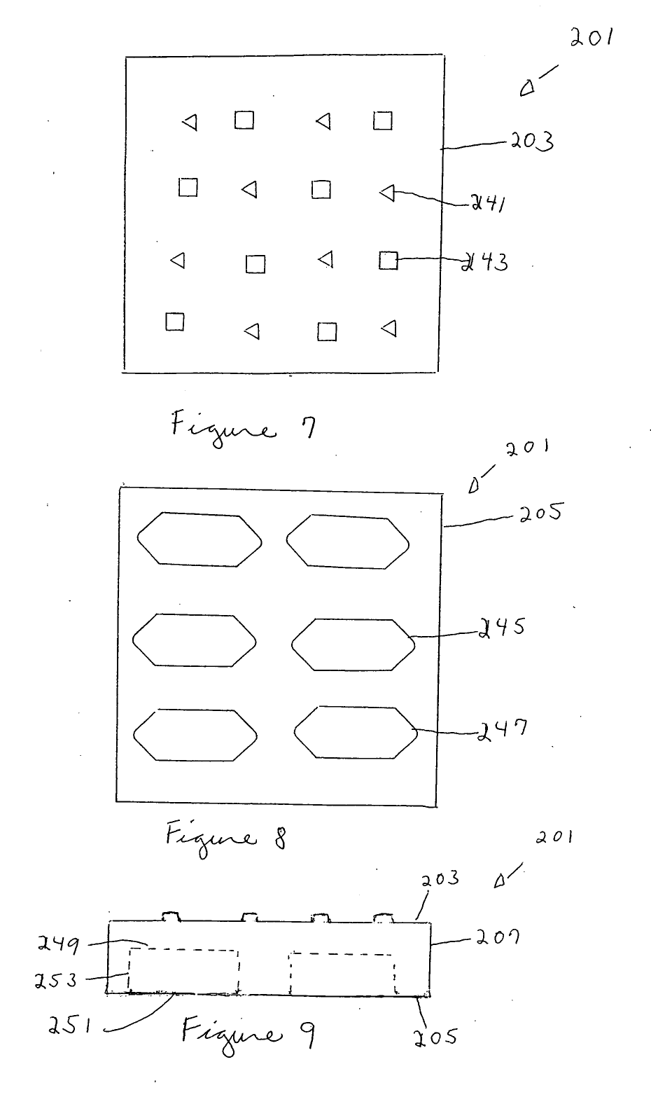

FIGS. 7, 8 and 9 are a top view, a bottom view and a side view, respectively, of yet another embodiment of a present invention recycled tire anti-vibration pad with protrusions 201, illustrating different shapes for a plurality of protrusions 241, 243.

The anti-vibration pad 201 includes at least one sidewall 207, a top 203 and a bottom 205. The top 203 has a plurality of protrusions 241, 243 and is adapted for placement under a potentially vibrating appliance. The bottom 205 has a plurality of recesses 245, 247, 253 extending at least half way into the at least one anti-vibration pad 201 and is adapted for placement on a surface where the potentially vibrating appliance is placed. The at least one anti-vibration pad 201 reduces noise and vibration of the potentially vibrating appliance when the at least one anti-vibration pad 201 is placed under the potentially vibrating appliance.

In this embodiment, the plurality of protrusions 241, 243 is in a symmetrical predetermined pattern of alternating triangles and squares. The protrusions 241, 243 may be textured.

In this embodiment, the plurality of recesses 245, 247, 253 is in a fixed pattern of two hexagons in width and three hexagons in length. Although the recesses are shown as hexagons, the shape of the recesses 245, 247, 253 may be circular, oval, square, rectangular, triangular, hexagonal, octagonal, polygonal, and combinations thereof. Each of the recesses 245, 247, 253 includes a top 251 and a bottom 249. In this embodiment, the recesses are not tapered. Thus, an area of each recess 245, 247, 253 from a two-dimensional perspective parallel to the bottom 205 of the at least one anti-vibration pad 201 remains the same throughout the length of the recess 245, 247 and 253.

In this embodiment, an extended footprint from a top 203 view is square. However, the extended footprint view from the top may be circular, oval, square, rectangular, triangular, hexagonal, octagonal and polygonal.

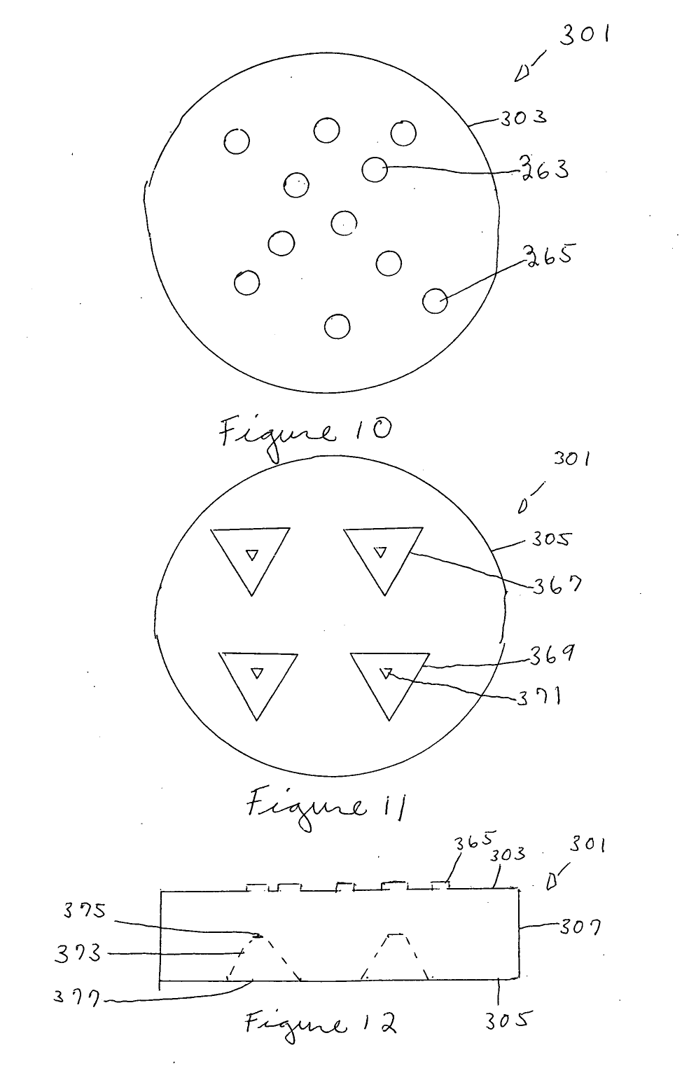

FIGS. 10, 11 and 12 are a top view, a bottom view and a side view, respectively, of yet another embodiment of a present invention recycled tire anti-vibration pad with protrusions 301, illustrating a different shape for the extended footprint from a top 303 perspective.

The anti-vibration pad 301 includes at least one sidewall 307, a top 303 and a bottom 305. The top 303 has a plurality of protrusions 363, 365 and is adapted for placement under a potentially vibrating appliance. The bottom 35 has a plurality of recesses 367, 369, 373 extending at least half way into the at least one anti-vibration pad 301 and is adapted for placement on a surface where the potentially vibrating appliance is placed. The at least one anti-vibration pad 301 reduces noise and vibration of the potentially vibrating appliance when the at least one anti-vibration pad 301 is placed under the potentially vibrating appliance.

In this embodiment, the plurality of protrusions 363, 365 is in a symmetrical predetermined pattern of circles. The protrusions 363, 365 may be textured.

In this embodiment, the plurality of recesses 367, 369, 373 is in a fixed pattern of triangles. Each of the recesses 367, 369, 373 includes a top 377 and a bottom 375. The recesses are tapered as illustrated by a smaller dimensioned triangle 371 within the recess 369. Thus, an area of each recess 367, 369, 373 from a two-dimensional perspective parallel to the bottom 305 of the at least one anti-vibration pad 301 increases from the bottom 375 of the recess 373 to the top 377 of the recess 373.

In this embodiment, an extended footprint from a top 303 view is circular. However, the extended footprint view from the top may be circular, oval, square, rectangular, triangular, hexagonal, octagonal and polygonal.

To summarize, the present invention thus provides an anti-vibration pad for reducing noise and vibration of a potentially vibrating appliance.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, in some preferred embodiments, before being melted and fused, the shredded rubber from used tires may be intermixed with an appropriate binding material, such as those used in the insides of a baseball, or any other available binder that works with rubber used in tires.

1-20. (canceled)

21. A recycled tire anti-vibration pad with protrusions which comprises:
at least one anti-vibration pad composed entirely of fused rubber shredded rubber from used tires and including at least one sidewall, a top and a bottom;
wherein said top includes a plurality of said protrusions and is adapted for placement under a potentially vibrating appliance;
wherein said bottom includes a plurality of recesses extending at least half way into said at least one anti-vibration pad and is adapted for placement on a surface where said potentially vibrating appliance is placed and wherein each of said plurality of recesses has a closed-loop periphery and none of said plurality of recesses overlap said at least one sidewall;
such that said at least one anti-vibration pad reduces noise and vibrations of said potentially vibrating appliance when said at least one anti-vibration pad is placed under said potentially vibrating appliance.

22. The recycled tire anti-vibration pad with protrusions of claim 21 wherein said plurality of said protrusions is in a fixed pattern.

23. The recycled tire anti-vibration pad with protrusions of claim 21 wherein said plurality of said protrusions is in a symmetrically predetermined pattern.

24. The recycled tire anti-vibration pad with protrusions of claim 21 wherein said shape of said protrusions is selected form the group consisting of circular, oval, square, rectangular, triangular, hexagonal, octagonal, polygonal and combinations thereof.

25. The recycled tire anti-vibration pad with protrusions of claim 21 wherein said plurality of recesses is in a fixed pattern.

26. The recycled tire anti-vibration pad with protrusions of claim 21 wherein said plurality of recesses is in a symmetrically predetermined pattern.

27. The recycled tire anti-vibration pad with protrusions of claim 21 wherein said shape of recesses is selected form the group consisting of circular, oval, square, rectangular, triangular, hexagonal, octagonal, polygonal and combinations thereof.

28. The recycled tire anti-vibration pad with protrusions of claim 21 wherein each of said recesses includes a top and a bottom and wherein an area of said recess from a two-dimensional perspective parallel to said bottom of said at least one anti-vibration pad increases from said bottom of said recess to said top of said recess.

29. The recycled tire anti-vibration pad with protrusions of claim 21 wherein said shape of recesses is selected form the group consisting of circular, oval, square, rectangular, triangular, hexagonal, octagonal, and polygonal.

30. The recycled tire anti-vibration pad with protrusions of claim 21 wherein said at least one anti-vibration pad is textured in a portion separate from said plurality of said protrusions.

31. A recycled tire anti-vibration pad with protrusions which comprises:
at least one anti-vibration pad composed entirely of fused rubber shredded rubber from used tires and including at least one sidewall, a top and a bottom;
wherein said top includes a plurality of textured said protrusions and is adapted for placement under a potentially vibrating appliance;
wherein said bottom includes a plurality of recesses extending at least half way into said at least one anti-vibration pad and is adapted for placement on a surface where said potentially vibrating appliance is placed and wherein each of said plurality of recesses has a closed-loop periphery and none of said plurality of recesses overlap said at least one sidewall;
such that said at least one anti-vibration pad reduces noise and vibrations of said potentially vibrating appliance when said at least one anti-vibration pad is placed under said potentially vibrating appliance.

32. The recycled tire anti-vibration pad with protrusions of claim 31 wherein said plurality of said protrusions is in a fixed pattern.

33. The recycled tire anti-vibration pad with protrusions of claim 31 wherein said plurality of said protrusions is in a symmetrically predetermined pattern.

34. The recycled tire anti-vibration pad with protrusions of claim 31 wherein said shape of said protrusions is selected form the group consisting of circular, oval, square, rectangular, triangular, hexagonal, octagonal, polygonal and combinations thereof.

35. The recycled tire anti-vibration pad with protrusions of claim 31 wherein said plurality of recesses is in a fixed pattern.

36. The recycled tire anti-vibration pad with protrusions of claim 31 wherein said plurality of recesses is in a symmetrically predetermined pattern.

37. The recycled tire anti-vibration pad with protrusions of claim 31 wherein said shape of recesses is selected form the group consisting of circular, oval, square, rectangular, triangular, hexagonal, octagonal, polygonal and combinations thereof.

38. The recycled tire anti-vibration pad with protrusions of claim 31 wherein each of said recesses includes a top and a bottom and wherein an area of said recess from a two-dimensional perspective parallel to said bottom of said at least one anti-vibration pad increases from said bottom of said recess to said top of said recess.

39. The recycled tire anti-vibration pad with protrusions of claim 31 wherein said shape of recesses is selected form the group consisting of circular, oval, square, rectangular, triangular, hexagonal, octagonal, and polygonal.

40. The recycled tire anti-vibration pad with protrusions of claim 31 wherein said at least one anti-vibration pad is textured in its entirety.
